(19) United States
(12) Patent Application Publication
(10) Pub. No.: US 2009/0002880 A1
(43) Pub. Date: Jan. 1, 2009

(54) INFORMATION STORAGE APPARATUS

(75) Inventors: Masanori Ueda, Kawasaki (JP); Haruyuki Matsunaga, Atsugi (JP)

Correspondence Address: GREER, BURNS & CRAIN, 300 S WACKER DR, 25TH FLOOR, CHICAGO, IL, 60606, US

(73) Assignee: FUJITSU LIMITED, Kawasaki-shi (JP)

(21) Appl. No.: 12/113,600

(22) Filed: May 1, 2008

Related U.S. Application Data
(63) Continuation of application No. PCT/JP2005/018149, filed on Sep. 30, 2005.

(51) Int. Cl. G11B 33/14

(52) U.S. Cl. 360/97.02; G9B/33.035

(57) ABSTRACT

An information storage apparatus includes: at least one information storage medium each of which is in a disk-like shape, rotates being fixed to a common rotating shaft and in which information is recorded; a head which accesses the information storage medium by approaching or touching the information storage medium; an arm which extends along a surface of the storage information medium, holds the head at an end of the arm, and swings around a pivot shaft disposed at a root of the arm; and a spoiler which rectifies airflow on the information storage medium and includes a metal airflow control plate and a resin bracket which holds the airflow control plate at a predetermined position along the surface of the information storage medium.

This application is a Continuation Application of International Application No. PCT/JP2005/018149, filed Sep. 30, 2005.

### TECHNICAL FIELD

The present invention relates to an information storage apparatus provided with an information storage medium.

### BACKGROUND ART

Conventionally a magnetic disk apparatus has been known as one kind of information storage apparatus using a disk-type information storage medium. The magnetic disk apparatus uses a magnetic disk as an information storage medium and reads and writes data by causing the magnetic head to approach or touch a surface of the magnetic disk rotating at high speed. Recently, typical magnetic apparatus is provided with multiple magnetic disks fixed to a common rotating shaft, in which magnetic heads respectively supported by carriage arms are inserted between respective pairs of magnetic disks and read data from and write data to the respective magnetic disks.

When the magnetic disks are rotated at high speed, airflow is generated between the respective pairs of magnetic disks. The airflow has an influence on each magnetic head and carriage arm inserted between the respective magnetic disks, resulting in deteriorated positioning accuracy of the magnetic head. In order to address this problem, a spoiler is used as a mechanical means to suppress such an influence of airflow on the positioning of the magnetic head and the carriage arm.

The spoiler is formed of an airflow control plate and a bracket. The airflow control plate suppresses turbulent airflow by being inserted between adjacent information storage media. The bracket holds the airflow control plate at a predetermined position between the information storage media. Accordingly, the spoiler is capable of preventing deterioration of positioning accuracy of a magnetic head by suppressing turbulent airflow (see, for example, Patent Documents 1 and 2).

Currently, a spoiler is manufactured by cutting a metal material, or by injection molding by which resin is injected into a mold and the solidified resin is drawn from the mold. Compared with a resin spoiler, a metal spoiler is superior because it is highly accurate in dimension, extremely rigid, and hard to change in dimension over time. However, the metal spoiler is costly because of long cutting time and, in addition, surface treatment as required for preventing corrosion and reducing dust particles from a metal material.

On the other hand, a resin spoiler can be manufactured in simple process and thus in low cost. However, the resin spoiler has a problem that it is inferior in rigidity and easier to change in dimension over time.

### Patent Document 1: Japanese Patent Application Publication No. 2004-152373

### Patent Document 2: Japanese Patent Application Publication No. 2004-234784

Along with the recent trend of increasing rotational speed of information storage media and its increasing surface recording density, improving positioning accuracy of a magnetic head is one of the important technical issues. To this end, an airflow control plate that is inserted between adjacent information storage media needs to have a larger area and a narrower space between the airflow control plate and the information storage medium in order to suppress turbulent airflow.

When a metal spoiler is made to have a larger airflow control plate and a narrower space between the airflow control plate and information storage media, higher-level processing technique as well as much more cutting time is required, which leads to increased costs. In addition, surface treatment failure at the back of the airflow control plate is likely to occur owing to deep recess between the airflow control plates.

On the other hand, when a resin spoiler is made to have a large airflow control plate, it should be considered that warpage at the end is likely to occur because of its inherent low rigidity and the spoiler is drawn easily from a mold. Thus, the airflow control plate needs to have a thin end because of a large draft gradient along the drawing direction. This is contrary to the demand for a narrow space between the airflow control plate and information storage media.

As described above, there are limits to a larger airflow control plate and a narrower space between the airflow control plate and information storage media. Therefore, it is difficult to improve positioning accuracy of a magnetic head of information storage apparatus and thus to enhance performance of the information storage apparatus.

Incidentally, such a problem is not limited to a magnetic disk apparatus, but also is common in information storage apparatus that access information by causing a disk-shaped information storage medium to rotate. In view of the above circumstances, the present invention provides an information storage apparatus that realizes high-speed rotation of an information storage medium and increased surface recording density.

### DISCLOSURE OF THE INVENTION

An information storage apparatus according to the present invention includes:

at least one information storage medium each of which has a disk-like shape and rotates being fixed to a common rotating shaft and in which information is recorded;

a head which accesses the information by approaching or touching the information storage medium;

an arm which extends along a surface of the information storage medium, holds the head at an end of the arm, and rotates around a rotation shaft disposed at a root of the arm; and

a spoiler which rectifies airflow on the information storage medium and includes a metal airflow control plate and a resin bracket which holds the airflow control plate at a predetermined position along the surface of the information storage medium.

Since the spoiler of the present invention uses a metal airflow control plate, the spoiler is superior in rigidity and dimensional accuracy as well as hard to change in dimension over time. In addition, the resin bracket of the spoiler of the present invention allows more simple and cheaper manufacturing. Thus, this invention allows a spoiler to have a large-area airflow control plate and a narrower space between the airflow control plate and the information storage medium, and to suppress turbulent airflow. Accordingly, the spoiler is capable of preventing deterioration of positioning accuracy of a magnetic head at an information storage apparatus with high-speed rotation and high surface recording density.

Preferably, the information storage apparatus according to the present invention may have plural information storage media, and the airflow control plate is disposed between the plural adjacent information storage media.

Even when storage capacity of the information storage apparatus having plural information storage media is enlarged, disposing the airflow control plate between the respective adjacent information storage media allows the apparatus to have a highly-accurate positioning of a head and high surface recording density.

Further preferably, in the information storage apparatus according to the present invention, the spoiler may be formed into one-piece by outsert molding in which a portion of the airflow control plate is placed in a mold for the bracket and the mold is filled with resin so that the bracket covers the portion of the airflow control plate.

The dimensional highly-accurate spoiler can be manufactured at a low cost by using the outsert molding, which produces a reliable and low-cost information storage apparatus.

In addition, the outsert molding allows surface treatment of the airflow control plate before manufacturing the spoiler, improving the reliability of surface treatment. Thus, it is possible to obtain a reliable information storage apparatus.

Further, it is preferable that, in the information storage apparatus according to the present invention, the bracket be made of a resin material mixed with a conductive filler.

Alternatively, it is preferable that, in the information storage apparatus according to the present invention, the bracket be made of a resin material mixed with a nano-carbon material.

Further, it is also preferable that, in the information storage apparatus according to the present invention, a conductive treatment be applied to a surface of the bracket.

The spoiler of the information storage apparatus according to the present invention is given conductivity by adding a conductive filler or a nano carbon material, or by applying a conductive surface treatment. Thus, generation of static electricity can be suppressed and thereby damage of electronic components due to electrostatic discharge can be prevented. Consequently, the information storage apparatus according to the present invention is reliable.

More preferably, in the information storage apparatus according to the present invention, the airflow control plate may have an aerodynamic shape in cross section.

The airflow control plate in an aerodynamic shape allows effective rectification of turbulent airflow generated between the information storage media. Thus, the information storage apparatus according to the present invention having such an airflow control plate is reliable.

As described in the above, the information storage apparatus according to the present invention can realize high speed rotation of the information storage medium, and improved surface recording density.

### BRIEF DESCRIPTION OF THE DRAWINGS

FIG. 1 is a schematic plan view of an information storage apparatus provided with a disk-type information storage medium according to the present invention.

FIG. 2 is an enlarged schematic perspective view of a first spoiler.

FIG. 3 is an enlarged schematic perspective view of a second spoiler.

FIG. 4 is a view illustrating a resin outsert molding.

FIG. 5 is a view illustrating swaging.

FIG. 6 is an enlarged schematic perspective view of a spoiler according to a third embodiment of the present invention.

### BEST MODE FOR CARRYING OUT THE INVENTION

Hereafter, embodiments of the present invention will be described referring to the attached drawings.

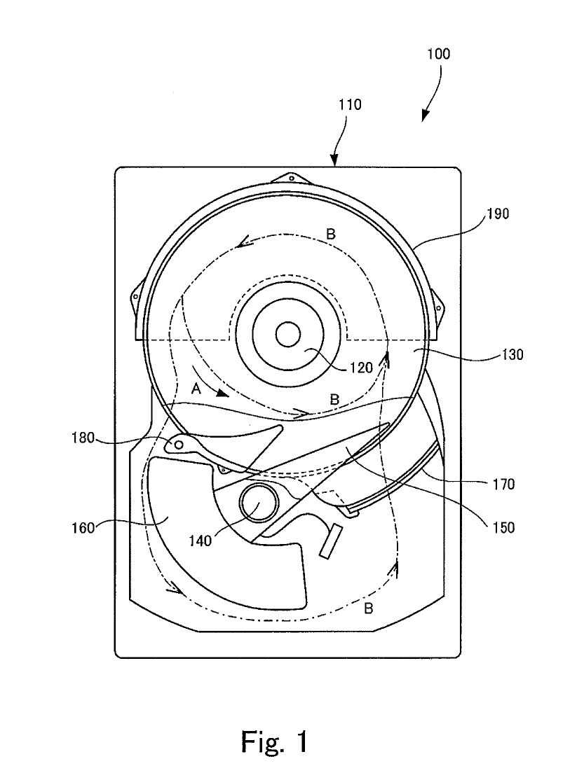

FIG. 1 is a schematic plan view of a magnetic disk apparatus that is a first embodiment of an information storage apparatus according to the present invention.

A magnetic disk apparatus 100 shown in FIG. 1 is used by being connected to or incorporated in a mainframe computer, a server computer, a personal computer or the like.

Typically, a magnetic disk apparatus has one or more magnetic disks, the number of which depends on its applications. Here, it is assumed that the magnetic disk apparatus 100 of the present embodiment has four magnetic disks. Accordingly, although only a top magnetic disk is shown in FIG. 1, the remaining three magnetic disks are disposed at intervals under the top magnetic disk.

The magnetic disk apparatus 100 includes: a housing 110; a rotating shaft 120; a magnetic disk 130 that is one kind of an information storage medium; a spindle motor (not shown) for causing the magnetic disk 130 to rotate in a direction indicated with an arrow A; an arm 150 that moves along a surface of the magnetic disk 130 around an arm shaft 140; and a magnetic circuit 160 for driving the arm 150. The arm 150 includes: a rigid carriage that is made by cutting a metal block and that is to be attached to the arm shaft 140; a driving coil fixed to the carriage; a floating head slider that is supported by a plate-spring suspension and faces a surface of the magnetic disk 130 in the vicinity of the surface; and a magnetic head mounted on the end of the head slider and accesses information written in the magnetic disk 130. In addition, an internal space of the housing 110 is enclosed by a cover (not shown).

The magnetic disk apparatus 100 writes information to and reproduces written information from the magnetic disk 130. As described above, four magnetic disks 130 are provided in the magnetic disk device 100. Therefore, eight arms 150 are provided, corresponding to eight surfaces of the four magnetic disks, i.e., front and back surfaces of each magnetic disk 130. A head stack assembly formed of the eight arms 150 is attached to the arm shaft 140 and caused to swing by electromagnetic force generated between the magnetic circuit 160 and driving coil fixed to the carriage. Rotation of the head stack assembly caused by the magnetic circuit 160 allows the floating head slider to settle at a desired track along the surface of the magnetic disk 130. A magnetic head sequentially approaches one-bit regions aligned in each track of the magnetic disk 130 and accesses information thereto by using a magnetic field.

Here, the magnetic disk 130 corresponds to an example of the information storage medium according to the present invention. In addition, the magnetic head and the arm 150 correspond respectively an example of the head and the arm according to the present invention.

Further, the housing of the magnetic disk apparatus 100 includes a filter 170, through which the airflow, being indicated by arrow B shown in FIG. 1, generated by rotation of the magnetic disk 130 passes. In this way, the filter 170 serves to adsorb and remove dust particles in the airflow and thereby keep the airflow clean. Since the air present between opposed surfaces of stacked magnetic disks is pulled by rotation of the magnetic disks, turbulent airflow is likely to be generated. The turbulent airflow vibrates the arm 150 and the suspension of the arm 150, which vibration is then transmitted to the floating head slider supported by the suspension, and causes deteriorated positioning accuracy of the magnetic head. In order to deal with such a problem, a first spoiler 180 and a second spoiler 190 are disposed to rectify airflow between the respective magnetic disks 130. The first spoiler 180 is disposed at the upstream of airflow with respect to the arm 150 to locally rectify airflow toward the arm 150. On the other hand, the second spoiler 190 is disposed opposite to the arm 150 across the rotation shaft 120, and covers an area as large as nearly half of the surface of the magnetic disk 130, and thereby suppresses the turbulence of airflow accompanying high speed rotation of the magnetic disk 130.

From now on, details of the first spoiler 180 and second spoiler 190 will be described.

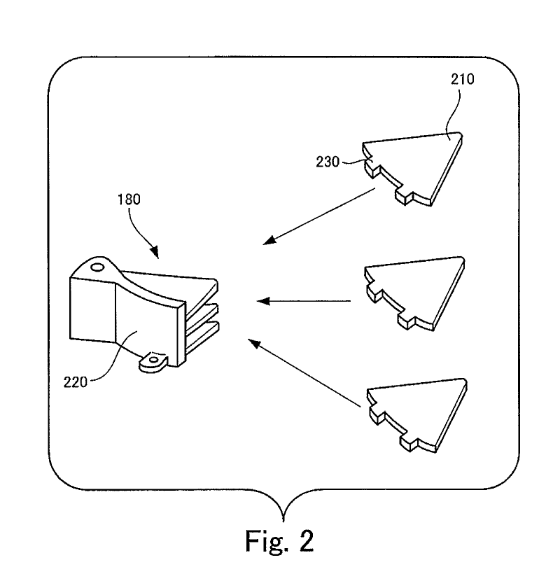

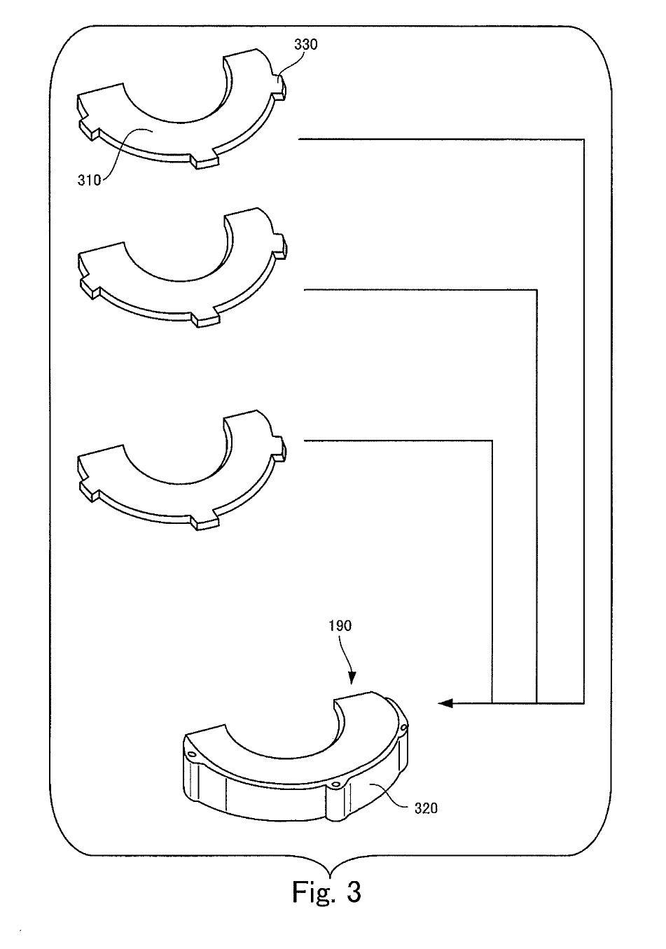

FIG. 2 shows an enlarged schematic perspective view of the first spoiler 180 and FIG. 3 shows that of the second spoiler 190.

The first spoiler 180 of FIG. 2 is formed of three metal airflow control plates 210 having an approximate triangle shape and a resin bracket 220 mixed with a conductive filler such as a carbon fiber and a metal filler. The second spoiler 190 of FIG. 3 is formed of three metal airflow control plates 310 shaped like letter C and a resin bracket 320 mixed with a conductive filler. Each of the airflow control plates 210, 310 is inserted between the respective adjacent magnetic disks to rectify airflow to the arm 150. The airflow control plates 210, 310 are made by processes such as die-cutting (stamping) of a metal plate and swaging of the metal plate, which will be described later in detail. In addition, a surface treatment is applied to the airflow control plates 210, 310 as required for preventing corrosion and reducing dust particles from a metal material. Further, protrusions 230 and 330 are formed on the airflow control plates 210, 310 to enhance joint strength between the airflow control plates 210, 310 and the brackets 220, 320. The brackets 220 and 320 serve to securely support the airflow control plates 210, 310 respectively at a predetermined position between the magnetic disks 130. The brackets 220 and 320 have conductivity because they are formed of resin mixed with a conductive filler. Therefore, they prevent electrostatic discharge and thus are capable of preventing damage of electronic components in the magnetic disk apparatus 100. Further, since the spoilers 180 and 190 are formed by resin outsert molding which will be described later in detail, the airflow control plates 210, 220 and the brackets 220, 320 are formed in one-piece.

Here, the first spoiler 180 and the second spoiler 190 each respectively correspond to an example of the spoiler according to the present invention; the airflow control plates 210 and 310 each correspond to an example of the airflow control plate according to the present invention; and the brackets 220 and 320 each correspond to an example of the bracket according to the present invention.

From now on, the above-mentioned resin outsert molding will be described, taking the first spoiler 180 of FIG. 2 as an example. It should be noted that the second spoiler 190 shown in FIG. 3 is formed similarly to the first spoiler 180.

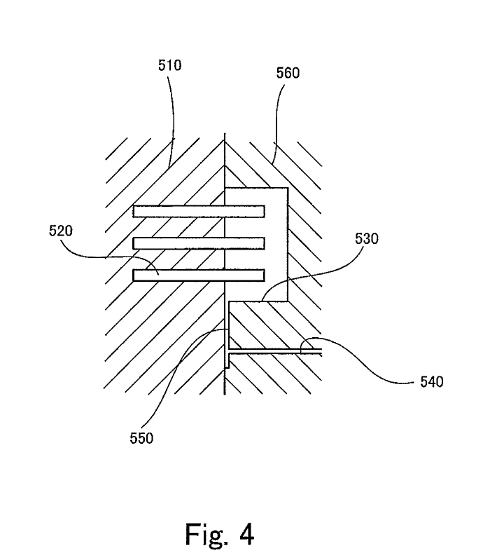

FIG. 4 is a view illustrating a resin outsert molding.

FIG. 4 shows a fixed mold 510 and a movable mold 560. The fixed mold 510 has recesses 520 in which the airflow control plates 210 are set with its end having the protrusions 230 protruding from the fixed mold 510. The movable mold 560 has a cavity 530 that outlines the bracket 220, a runner 550 for guiding resin into the cavity 530, and a spool 540 from which resin is injected into the runner 550. The airflow control plates 210 are set into the fixed mold recesses 520. Next, the movable mold 530 is clamped on the fixed mold 510, and subsequently resin is injected from the spool 540 into the cavity 530 via the runner 550. When the cavity 530 that outlines the bracket 220 is filled with resin, the mold is cooled down to solidify the resin. Then, the movable mold 560 is separated from the fixed mold 510, the solidified resin is ejected, and any excess resin is removed. This resin outsert molding finishes the first spoiler 180 shown in FIG. 2 in which three airflow control plates 210 are integral with the bracket 220.

It is possible to manufacture a dimensional highly-accurate spoiler at a low cost, because such an integral (one-piece) spoiler with metal airflow control plates and a resin bracket is formed by the resin outsert molding

From now on, swaging will be described.

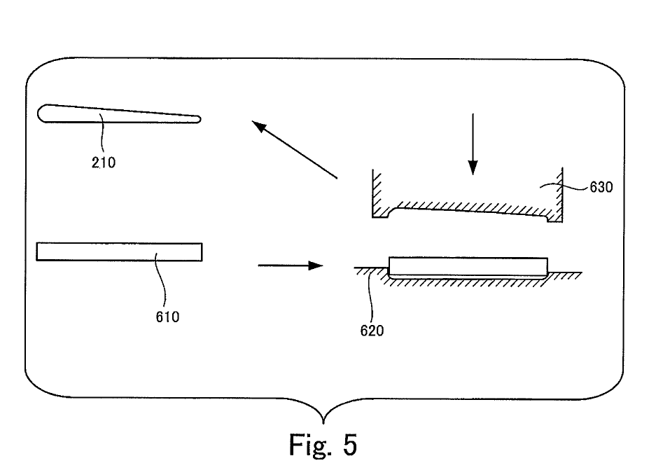

FIG. 5 is a view illustrating the swaging.

Here, descriptions will be made on the swaging by which the airflow control plate 210 of the first spoiler 180 is manufactured.

FIG. 5 shows a fixed die 620 having a recess to set a metal plate 610 and a movable die 630 with a recess to form a cross section of the metal plate 610 into an aerodynamic shape. In swage process, the metal plate 610, which is stamped into such a plane form as the airflow control plate 210, is fit into the fixed die 620 and then the movable die 630 is pressed against the fixed die 620 by a press machine. As a result, a cross section of the metal plate 610 is formed into an aerodynamic shape, which finishes the airflow control plate 210. The airflow control plate 210 manufactured by the swaging described above can effectively rectify airflow because it is aerodynamic in its cross section.

As described above, since the resin outsert molding and swaging allows manufacturing of a dimensional highly-accurate spoiler at a low cost, the information storage apparatus according to the present invention is reliable and manufactured at a low cost.

According to the example described in the first embodiment, a conductive filler such as carbon fibers is mixed in a bracket to make the bracket conductive. Alternatively, when a nano-carbon material typified by a carbon nano tube material is mixed in the bracket, a satisfactory spoiler is also obtained. A second embodiment of the present invention is a magnetic disk apparatus having a spoiler in which a bracket is made of a nano-carbon material, instead of the spoiler provided in the magnetic disk apparatus 100 shown in FIG. 1. Since the structure of the second embodiment is similar to that of the first embodiment, description of the second embodiment referring to a drawing is omitted.

Hereafter, a third embodiment of the present invention will be described.

A magnetic disk apparatus according to the third embodiment is same as that according to the first embodiment except for a structure of a spoiler. Thus, the following descriptions focus on the structure of the spoiler.

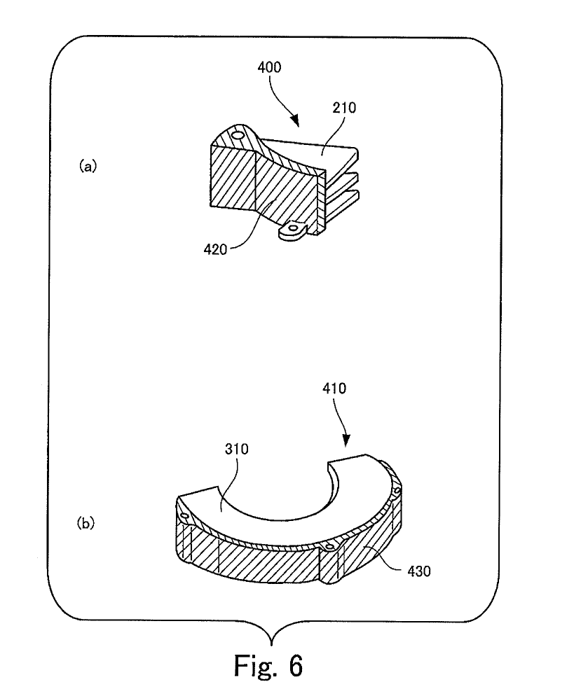

FIG. 6 is a schematic perspective view of a spoiler according to the third embodiment of the present invention.

FIG. 6 shows a first spoiler 400 and a second spoiler 410 of the third embodiment, which are different from the embodiments described above. It should be noted that the elements in FIG. 6 identical with those shown in FIGS. 2 and 3 are designated with the same reference numbers as FIGS. 2 and 3 and their further descriptions are omitted.

The first spoiler 400 and the second spoiler 410 shown in FIG. 6 respectively have brackets 420 and 430 to which surface conductivity is treated by soaking the brackets in a treatment liquid. The spoilers 400 and 410 each are also an example of the spoiler according to the present invention, and the brackets 420 and 430 each are also an example of the bracket according to the present invention.

The brackets 420 and 430 that have undergone conducting treatment shown in FIG. 6 are formed of pure resin unlike the brackets 220 and 320 shown in FIGS. 2 and 3. Since the brackets 420 and 430 do not include a conductive filler, they are free from dust particles generated from a conductive filler. Thus, the magnetic disk apparatus of the third embodiment is reliable.

In the above descriptions the magnetic disk apparatus is taken as an example of the information storage apparatus, however, the information storage apparatus according to the present invention may be any other apparatus as long as it uses a disk-shaped storage medium.

1. An information storage apparatus comprising:
at least one information storage medium each of which has a disk-like shape and rotates being fixed to a common rotating shaft and in which information is recorded;
a head which accesses the information by approaching or touching the information storage medium;
an arm which extends along a surface of the information storage medium, holds the head at an end of the arm, and rotates around a rotation shaft disposed at a root of the arm; and
a spoiler which rectifies airflow on the information storage medium and includes a metal airflow control plate and a resin bracket which holds the airflow control plate at a predetermined position along the surface of the information storage medium.

2. The information storage apparatus according to claim 1, further comprising a plurality of the information storage media, wherein the airflow control plate is disposed between the plural adjacent information storage media.

3. The information storage apparatus according to claim 1, wherein the spoiler is formed into one-piece by outsert molding in which a portion of the airflow control plate is placed in a mold for the bracket and the mold is filled with resin so that the bracket covers the portion of the airflow control plate.

4. The information storage apparatus according to claim 1, wherein the bracket is made of a resin material mixed with a conductive filler.

5. The information storage apparatus according to claim 1, wherein the bracket is made of a resin material mixed with a nano-carbon material.

6. The information storage apparatus according to claim 1, wherein a conductive treatment is applied to a surface of the bracket.

7. The information storage apparatus according to claim 1, wherein the airflow control plate has an aerodynamic shape in cross section.
